(19) United States
(12) Patent Application Publication
(10) Pub. No.: US 2005/0268213 A1
(43) Pub. Date: Dec. 1, 2005

(54) System and method for automating job management in mobile data collection

(76) Inventors: Peiya Liu, East Brunswick, NJ (US); Sridharan Palanivelu, Plainsboro, NJ (US); Liang H. Hsu, Irvine, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/122,845

(22) Filed: May 5, 2005

Related U.S. Application Data
(60) Provisional application No. 60/568,522, filed on May 6, 2004.

(51) Int. Cl. G06F 17/21

(52) U.S. Cl. 715/500.1

(57) ABSTRACT

A datasheet processing method for publishing and collecting datasheets includes performing datasheet operations and assigning datasheets to the jobs. Mobile terminals are updated by loading the assigned datasheet and the user collects field data by using the assigned datasheet. Mobile terminals are then synchronized with the local database by using the collected field data and the local database contents are uploaded to a central computer.

### CROSS-REFERENCE TO RELATED APPLICATION

This application claims the benefit of U.S. Provisional Application No. 60/568,522 filed on May 6, 2004, titled as “Automated Method for Managing Jobs in Field Data-Collection”, contents of which are incorporated herein by reference.

### TECHNICAL FIELD

The present invention generally relates to data processing and more particularly to electronic processing of data collected in forms format.

### DISCUSSION OF THE RELATED ART

Capturing data at the source of an activity is crucial for accurate data-processing. Data can be captured by noting down the activity related information on forms. Form based data-collection is performed in many field service applications. Form based data-collection can be performed using paper forms, electronic forms provided through hand-held terminals, etc.

Once the data is collected in the format of forms it can be processed electronically after transferring to a computer readable format if necessary. However, forms in which data is collected cannot be always mapped directly to database structures for storing the data in the forms. Hence, there is a need to facilitate and automate data collection jobs for applications that involve field service management.

Many field service applications (e.g., a plant outage planning, etc) require storing the form data into a local database for securing collected data without the loss of data during service execution. It also makes it easier for data analysis to be performed after the field services without reentering the data into a form.

Conventionally, data collection form and data are stored in a single file without clean semantics and hence the export of data, structure, and semantics to different applications may not be easily possible. Documents authored in XML (eXtensible Markup Language) formats have opened up new more effective ways for document sharing and processing. The documentation process can be automated in many areas in the document lifecycle. However, traditional operation-centric techniques of automating data capturing and processing have constraints in integrating various forms and programs in a coherent manner. Hence, there is a need for techniques that will allow easy capture of form data into databases and enable further data processing for the captured data.

### SUMMARY OF THE INVENTION

In at least one aspect of the invention a datasheet processing method for publishing and collecting datasheets includes performing copy, update and store operations on datasheet forms sourced from a forms database into a local database on a computer system; and assigning the datasheet forms to one or more jobs from a list of jobs stored on the computer system. Mobile terminals are updated by loading the assigned datasheet form from the local database, the mobile terminals store the assigned datasheet form on a mobile database and the user collects field data by using the assigned datasheet. The mobile terminals are synchronized with the local database by using the collected field data to update the local database contents of which are uploaded to a central computer.

In at least one another aspect of the invention a mobile data collection system includes a form manager for performing datasheet operations and storing one or more datasheet forms in a markup language format, a mobile database for storing one or more jobs, forms and collected data; a job manager for organizing data collected by one or more mobile terminals through the jobs using the datasheet forms which are stored in the mobile database by the form manager module; and a data collector for performing data operations on the data collected through the mobile terminals and the datasheet forms.

### BRIEF DESCRIPTION OF DRAWINGS

Exemplary embodiments of the present invention are described with reference to the accompanying drawings, of which:

FIG. 1 is a block diagram showing a data collection architecture in an embodiment of the invention;

FIG. 2 is a flowchart for a job manager module's functions;

FIG. 3 is a continuation of the flowchart in FIG. 2 for the job manager's functions;

FIG. 4 is flowchart showing the operations of a data-collector module;

FIG. 5 is a flowchart showing the data-management and other functions performed by the job manager;

FIG. 6 shows an exemplary interface for a job manager in an exemplary embodiment of the invention;

FIG. 7a shows an exemplary data collector interface in an exemplary embodiment of the invention;

FIG. 7b shows a handheld terminal running an exemplary data-collector in an exemplary embodiment of the invention;

FIG. 8a shows an exemplary job information table in an exemplary embodiment of the invention;

FIG. 8b shows an exemplary extended job information table in an exemplary embodiment of the invention;

FIG. 9a shows an exemplary unit lookup table in an exemplary embodiment of the invention;

FIG. 9b shows an exemplary unit-event lookup table in an exemplary embodiment of the invention;

FIG. 10a shows a datasheet information table in an exemplary embodiment of the invention;

FIG. 10b shows an exemplary datasheet index template table in an exemplary embodiment of the invention;

FIG. 11a shows a datasheet categories table in an exemplary embodiment of the invention;

FIG. 11b shows an exemplary datasheet index table in an exemplary embodiment of the invention;

FIG. 12 shows a datasheet table in an exemplary embodiment of the invention;

FIG. 13 shows an outline diagram for data collection and handling using mobile terminals in an exemplary embodiment of the invention; and

FIG. 14 shows an exemplary computer system used to implement an exemplary embodiment of the invention.

### DETAILED DESCRIPTION OF THE EXEMPLARY EMBODIMENTS

The exemplary embodiments of the present invention will be described with reference to the appended drawings.

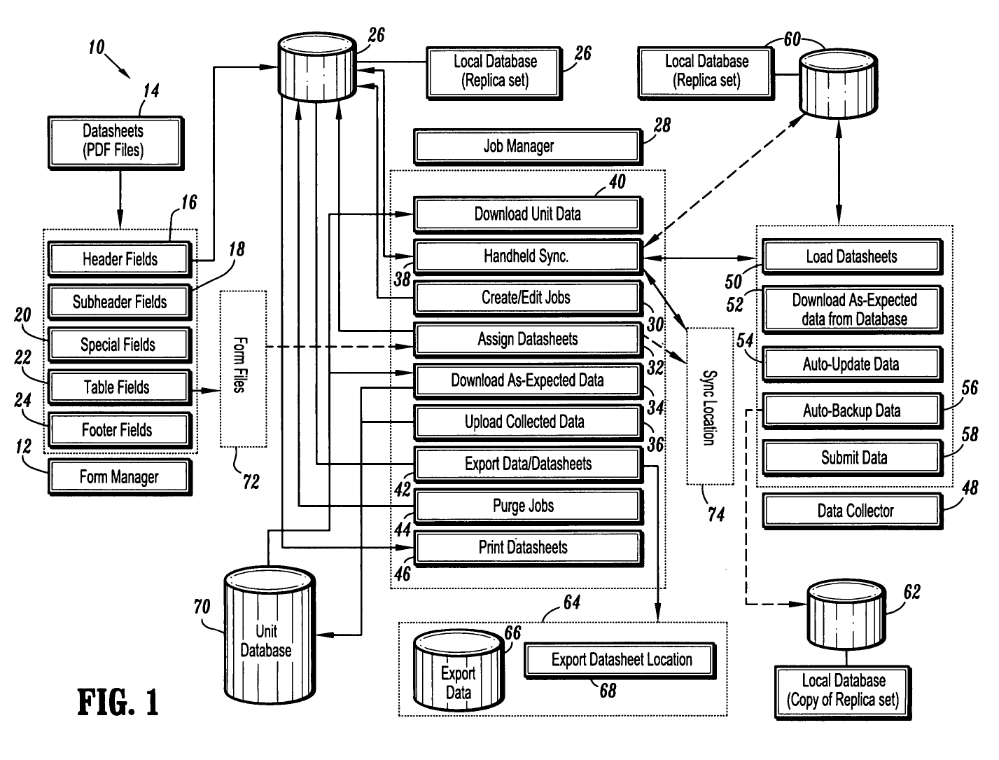

FIG. 1 is a block diagram showing a data collection architecture in an embodiment of the invention. A mobile data collection architecture 10 provides functions for collecting data from forms filled in either manually or using a device such as a hand-held terminal. Data collections jobs are structured as assigning datasheets (i.e., data collection forms) in a computer, pre-load as-expected data into datasheets, download datasheets from the computer running the job manager to handheld computers/terminals, collect data in the field about activities using the handheld computers/terminals, synchronize the data collected in the handhelds with the computer running the job manager, upload datasheets with loaded data back to a central computer (e.g., a back-office datacenter) and then upload data to the database and other network locations, etc.

A form manager 12 manages datasheets operations such as copying, updating, storing PDF (Portable Document Format) files and form field specifications in XML (extendible Markup Language), etc. Form manager 12 processes datasheets 14 (which can be in a PDF format) to specify the extraction of header fields 16, sub-header fields 18, special fields 20, table fields 22 and footer fields 24. Header fields are stored in a first local database replica 26.

Job Manager 28 administers tasks such as a jobs task 30 for creating and editing jobs; an assign datasheets task 32; a download-as-expected data task 34; an upload data task 36; and a synchronization task 38 which is used to synchronize data capture devices such as laptops, hand-held terminals, etc. Job Manager 28 also performs a download unit data task 40, an export data task 42, a purge job task 44 and a print datasheets task 46. The export data task 42 exports data to be stored in an export data-store 64 which includes an export data-sheet location 68 and an export database 66. The download unit data task 40 receives data from a unit database 70; the download as-expected data task 34 and the upload collected data task 36 stores the data downloaded in the unit database 70.

A data-collector 48 administers data collection and completeness checking function. In particular, the data-collector 48 performs a loading datasheets task 50, a downloading as-expected data task 52, an auto updating task 54, an auto backing up task 56 and a submit data task 58. The data collector 48 uses a second local database replica 60. The auto-updating task 54 uses a local database replica copy 62 which is a copy of the second local database replica 60.

Form files 72 are generated by the form manager 12 and are used as inputs for the assign data-sheets task 32. A synchronized location 74 is generated through the synchronization task 38 and the assign datasheets task 32.

The first local database replica 26 provides a database for the jobs task 30, the assign datasheets task 32, and the purge jobs task 44, the synchronization task 38, export data task 42 and print datasheets task 46.

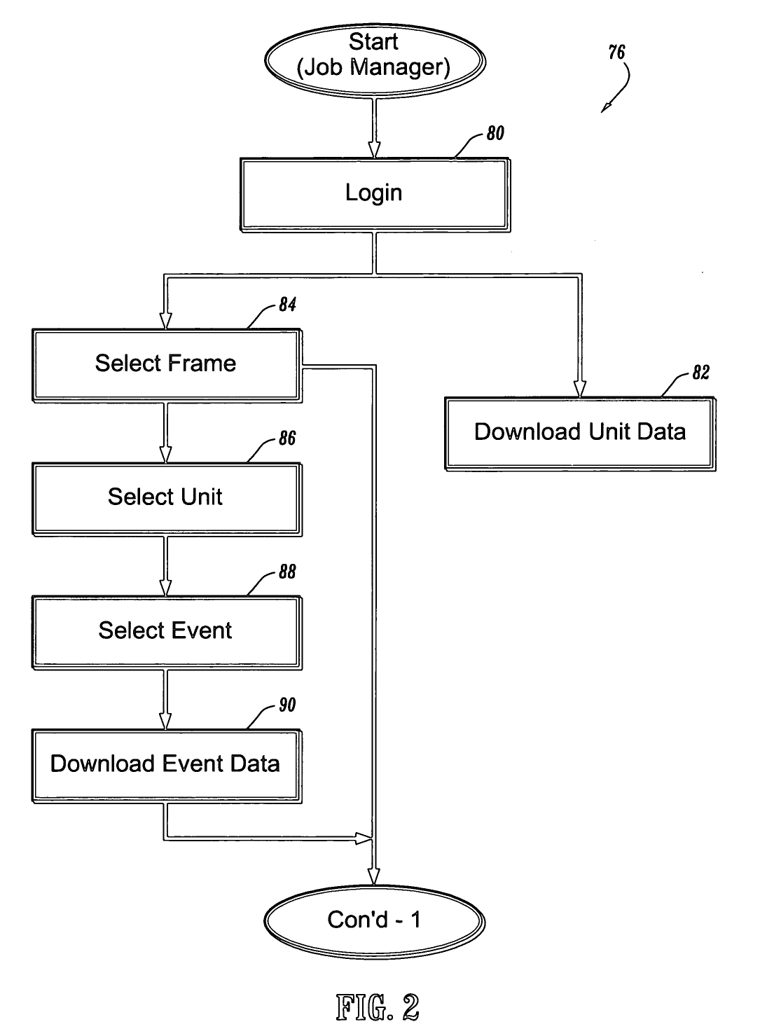

FIG. 2 is a flowchart for job manager module's functions. Job Manager 28's (See FIG. 1) operations start at a step 80 where a user logs in to the system to invoke the job manager 28. At a step 82, the job manager 28 downloads unit data from the unit database 70 (See FIG. 1). Downloading of the unit data is performed only if necessary. Unit data can include identifiers for physical or logical entities (e.g., machine numbers, parts numbers, etc).

At a step 84, a frame is selected. A frame can include data that is related to the unit data (e.g., a frame can include machine models while unit data can be specific machine identifiers). At a step 86, a particular unit is selected. At a step 88, an event is selected by the user from a list. Event data is downloaded at a step 90 along with datasheet template/attribute information to a local database.

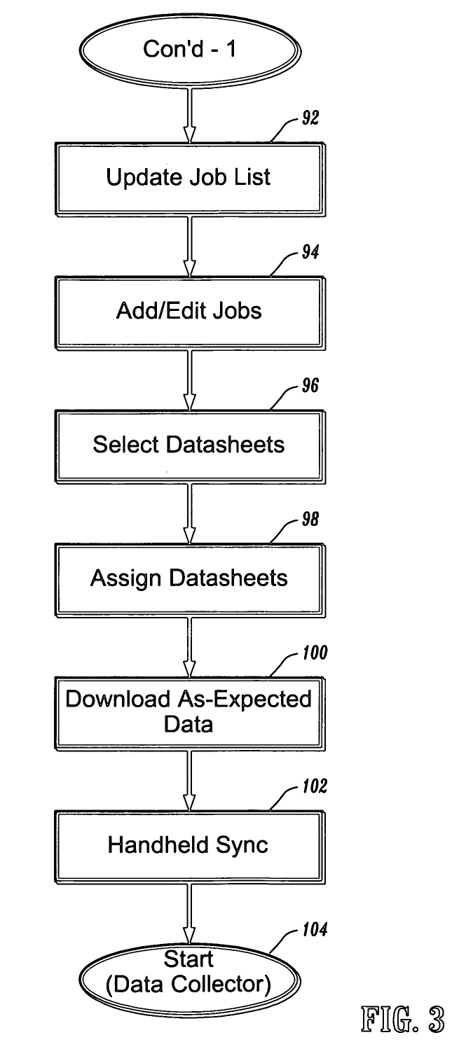

FIG. 3 is a continuation of the flowchart in FIG. 2 for the job manager's functions. At a step 92, a job list is updated for the selected frame. The job list can contain job items that are used to describe an event of field data collection associated with datasheet assignment, accounting charge, etc. At a step 94, jobs are either added or edited. At a step 96, datasheets are selected. At a step 98, the selected data sheets are assigned to a selected job. At a step 100, the as-expected data is downloaded from the assigned datasheets. As-expected data can be data loaded from backend computers about previous instances of occurrences or relevant standard data. For example, as expected data can be data about machine components from last update from back-end systems. Thus, engineers load the “as-expected-data” into datasheets from the backend systems before going into service fields.

In the field service applications, engineers can quickly check if the as expected data are the same as the real machine component data from the fields. Data from the downloaded as-expected data, datasheets and forms is synchronized between a handheld data collection device or terminal and the computer storing the data. At a step 104, a data collector 104 starts operation.

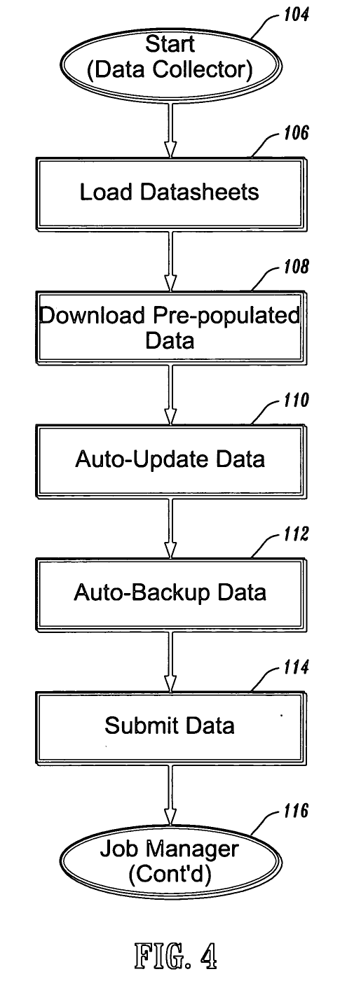

FIG. 4 is flowchart showing the operations of a data-collector module. At step 104, the data-collector is initiated. The data collector 48 (See FIG. 1) loads data sheets and form files that can be in a XML format at a step 106. The data collector 48 downloads pre-populated data at a step 108 from corresponding table for the datasheet based on a job identifier from the associated form file. The pre-populated data can include drawings, notes, etc. At a step 110 the data from the datasheets is auto-updated to corresponding tables based on the job identifier from the associated form file. At a step 112 the database instance is backed up to a specified location periodically. At a step 114 the store collected data and associated media (e.g., drawings, notes, etc) are stored to the database.

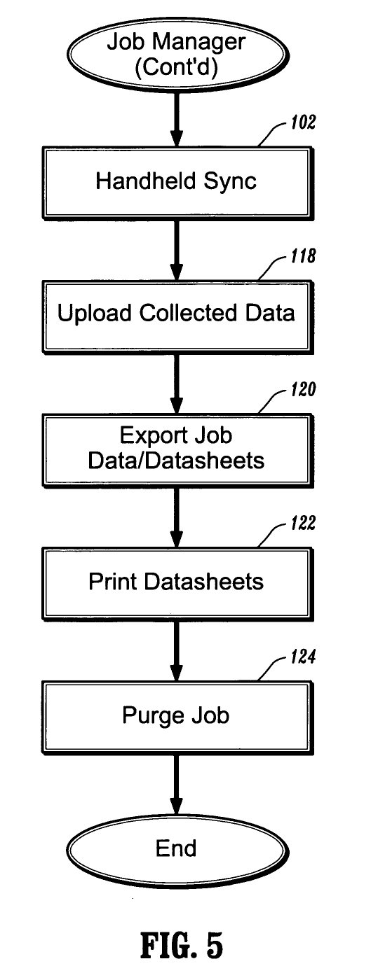

FIG. 5 is a flowchart showing the data-management and other functions performed by the job manager. Step 102 for performing handheld synchronization is performed as shown in FIG. 3 and described above. At a step 118, the collected data is uploaded after reading the collected data from each of datasheet tables in the database. At a step 120, the job data and datasheets are exported for the selected job to a computer or an output device. For example, a final PDF document can be exported that includes collected data, drawings and notes. At a step 122 the job manager 28 (See FIG. 1) prints the selected blank or filled datasheets to a printer. At a step 124, upon a user choosing to purge a job, the job manager 28 traverses through all the datasheet tables to delete the data corresponding to the selected job.

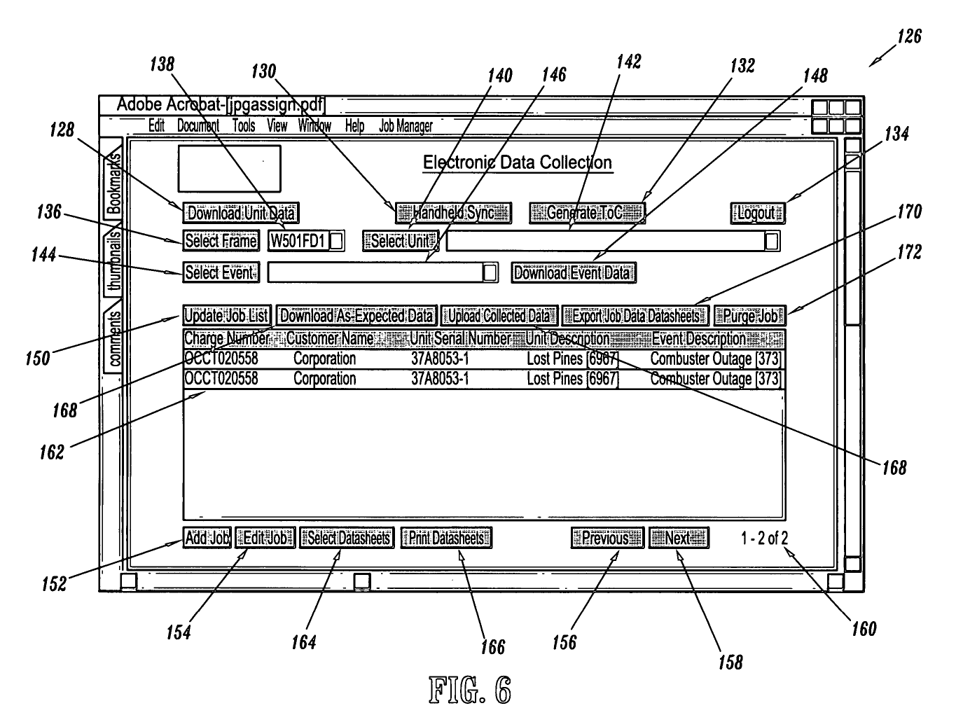

FIG. 6 shows an exemplary interface for a job manager in an exemplary embodiment of the invention. An interface 126 shows various job manager 28's (See FIG. 1) functions described above that can be controlled by the user. Control 128 enables downloading of all available unit information. Control 130 enables handheld synchronization. Control 132 enables generation of XML table of contents for data collector navigation based on the assigned datasheets and checklists.

Control 134 enables logging out of the job manager. Control 136 enables downloading of all frames. Control 138 enables selecting a frame from the drop down list. Control 140 enables downloading of all the available inputs. Control 142 enables selection of a unit from a drop down list. Control 144 enables selection of all the events for the selected unit. Control 146 enables selection of an event from a drop down list. Control 148 enables downloading of information about the selected event.

Control 150 enables the updating of the job list with the available jobs for the selected unit. Control 152 enables creation of a new job for the selected unit. Control 154 enables editing of a job from the list of jobs. Controls 156 and 158 enable scrolling in the job list. Control 160 is a status bar indicating the range of jobs displayed. Control 162 shows the job list for the selected unit. Control 164 enables assigning/non-assigning of datasheets/checklists for the selected job. Control 166 enables printing of all selected datasheets to a printer. Control 168 enables downloading of as-expected data for the available datasheets or only the assigned datasheets for the selected jobs. Control 170 enables export of the data and the filled datasheets to a selected location. Control 172 enables purging all related datasheets and data for the selected job.

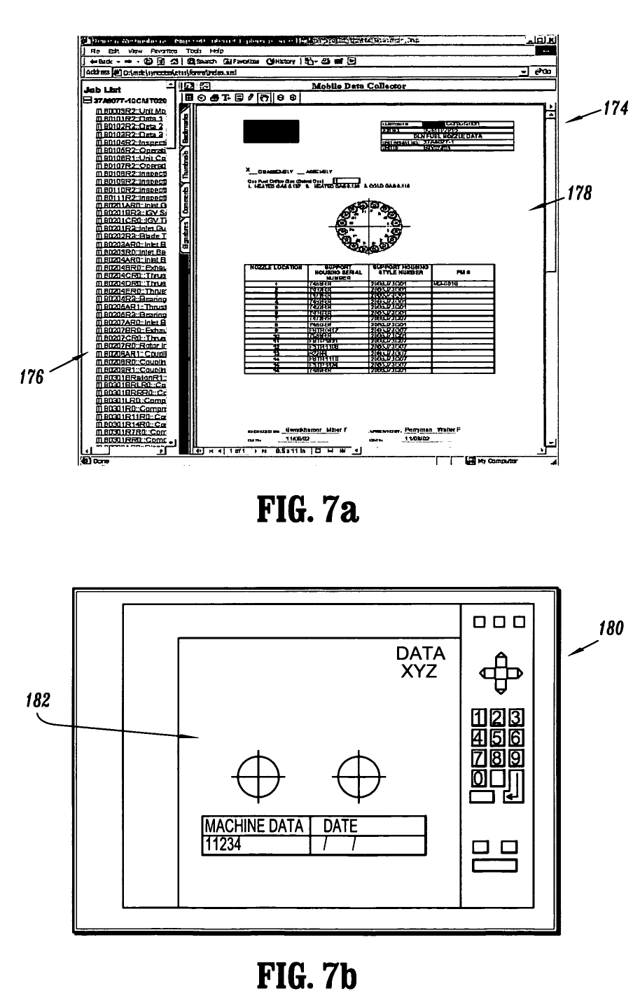

FIG. 7a shows an exemplary data collector interface in an exemplary embodiment of the invention. FIG. 7b shows a handheld terminal running an exemplary data-collector in an exemplary embodiment of the invention. A data-collector interface 174 includes a job list 176 and a data-collection form 178. A handheld terminal 180 is shown as running a data-collection interface 182 which is another example of the data collector interface 174.

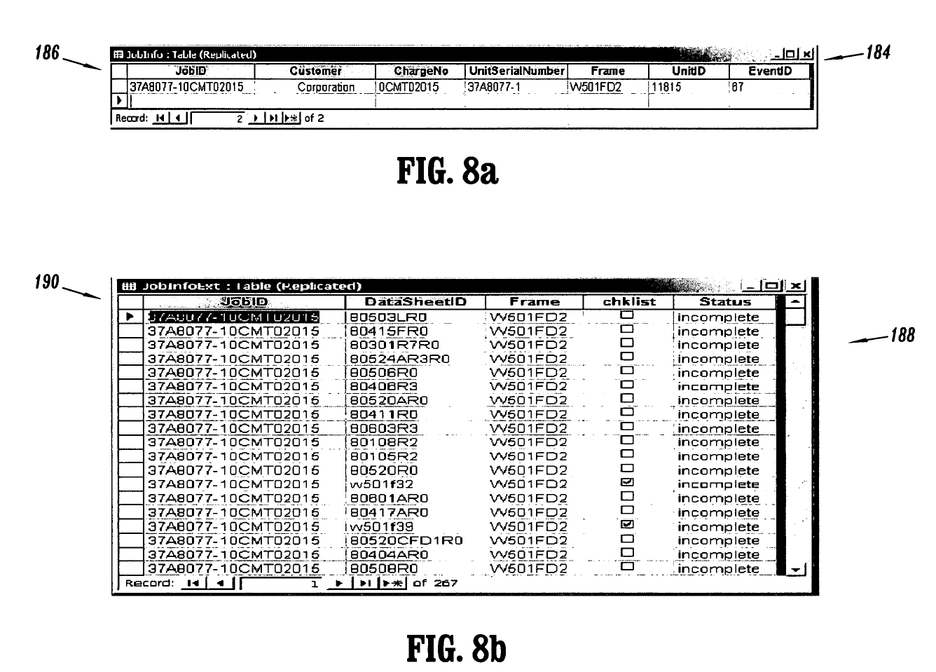

FIG. 8a shows an exemplary job information table in an exemplary embodiment of the invention. FIG. 8b shows an exemplary extended job information table in an exemplary embodiment of the invention. The local database replica 26 and its copies 60 and 62 (See FIG. 1) are used to store the data collected from the field. This database 26 can include different type of data like job information, unit information, even information, data collected on-site, drawings and notes. Table 184 stores job related information and it includes fields 186 such as a job identifier, a customer identifier, a charge number, a unit serial number, a frame, unit and event identifiers.

Extended job information table 188 stores extended job information. The table 188 can include fields 190 for job identifiers, data sheet identifiers, frames, checklists and status'. For each datasheet available to add and edit there must be a record in the table 188.

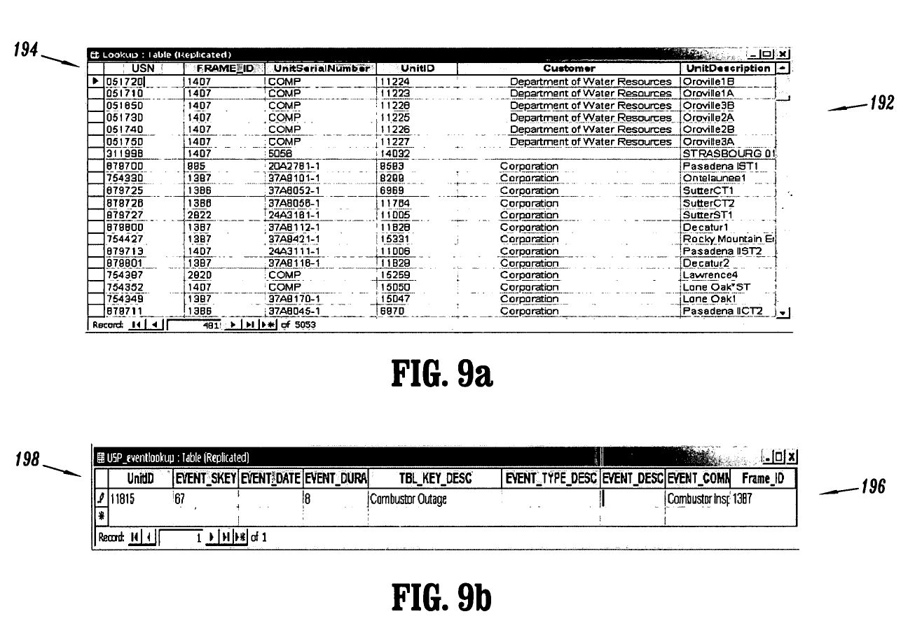

FIG. 9a shows an exemplary unit lookup table in an exemplary embodiment of the invention. FIG. 9b shows an exemplary unit-event lookup table in an exemplary embodiment of the invention. Unit lookup table 192 can include fields 194 for unit series number (USN), frame identifier, unit serial number, unit identifier, customer identifier and unit description. The unit lookup table 192 includes information related to available units. Unit event lookup table 196 is used to download the event related information for a selected unit to the local database (e.g., the database 26 in FIG. 1) offline use. The unit lookup table 192 can include fields for unit identifiers, event keys, event dates, event durations, key descriptors, event type descriptors, event descriptions, event comments and frame identifiers.

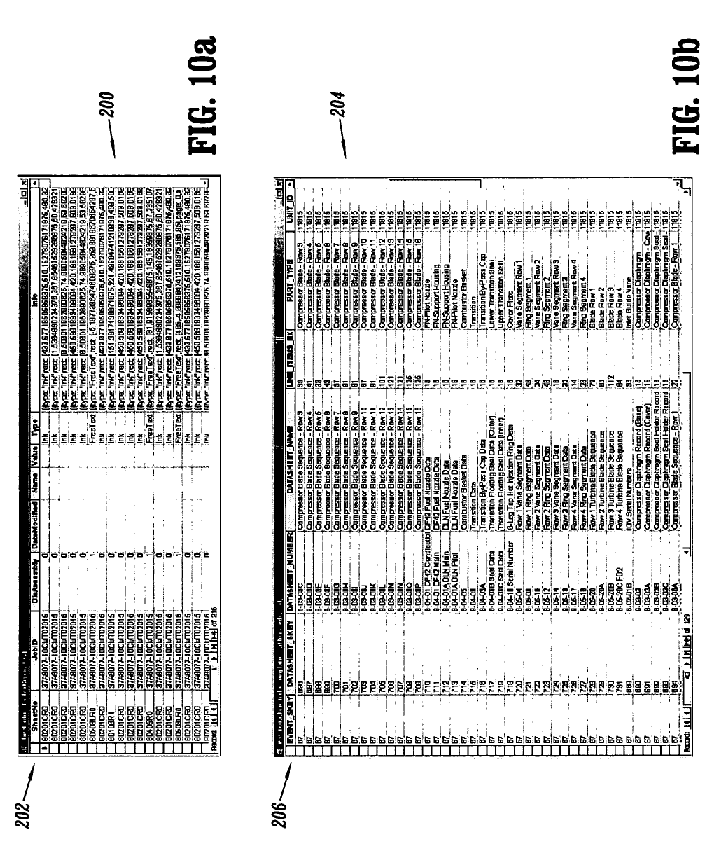

FIG. 10a shows a datasheet information table in an exemplary embodiment of the invention. FIG. 10b shows an exemplary datasheet index template table in an exemplary embodiment of the invention. Datasheet information table 200 stores drawings, notes and other annotations from the datasheet(s) for a specific job. The table 200 can include fields 202 for job identifiers, sheet numbers, disassemblies, modification dates, names, values, types and information.

A datasheet index template table 204 stores information that defines the attributes that appear on each datasheet. All the information for this table will be downloaded from the unit database along with event information. The table 204 can include fields 206 for event keys, datasheet keys, datasheet numbers, datasheet names, datasheet line items expected, part types, and unit identifiers.

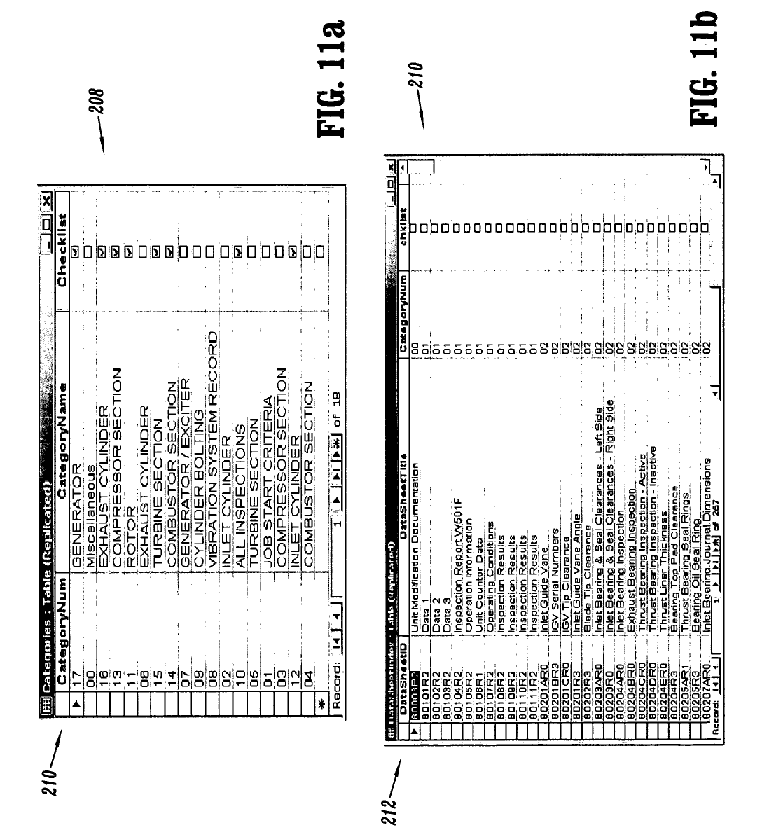

FIG. 11a shows a datasheet categories table in an exemplary embodiment of the invention. FIG. 11b shows an exemplary datasheet index table in an exemplary embodiment of the invention. Datasheet categories table 208 can include fields 210 for category numbers, category names and checklists. Datasheet index table 210 can include fields such as data sheet identifiers, datasheet titles, category numbers and check lists. The tables 208 and 210 are not accessed directly by the user but are used internally by the application.

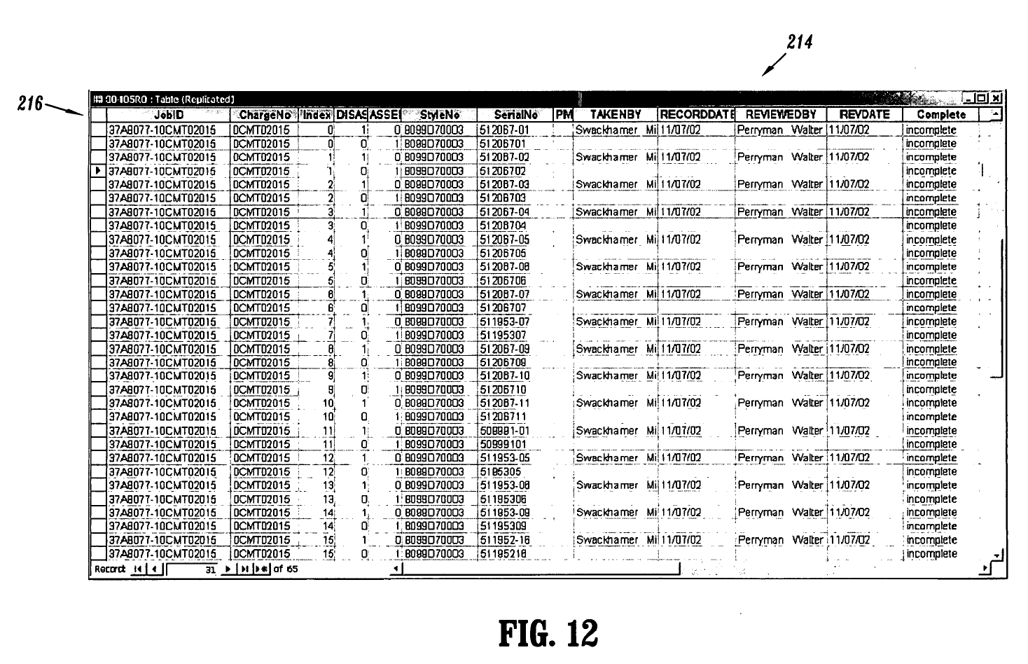

FIG. 12 shows a datasheet table in an exemplary embodiment of the invention. The datasheet table 214 holds the actual data entered by a user recording the data. Each datasheet which is accessible through the application stores its data in the datasheet table 214. The datasheet table 214 holds data for all the datasheets of a specific type. For each assigned datasheet there must be a record in the job information extension table 188 (See FIG. 8b) The records in the datasheet table 214 correspond with the information collected by the data collector 48 (See FIG. 1). In the datasheet table 214 there will be a record containing the matching job identifier from the job information extension table 188.

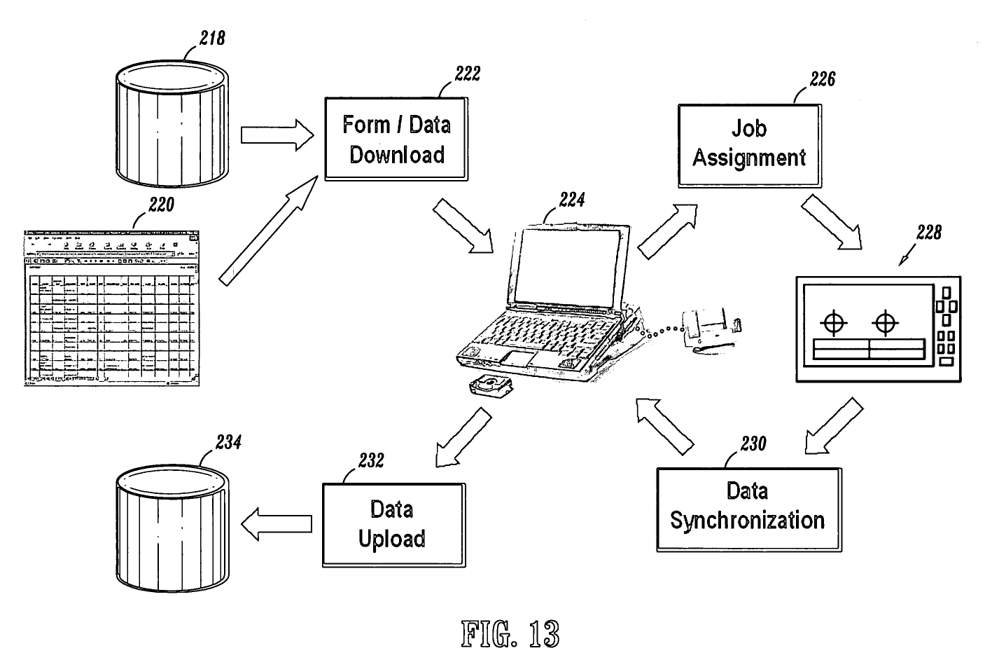

FIG. 13 shows an outline diagram for data collection and handling using mobile terminals in an exemplary embodiment of the invention. Form files 72 (See FIG. 1) stored in a database 218 and datasheets 220 (which are the datasheets 14 of FIG. 1 shown in another view) are sourced/downloaded as shown in an operation 222 to a computer 224. The form files 72 and the datasheets 220 are then assigned to jobs at an operation 226 which are then downloaded to a mobile terminal 228 which is used to collect data in the field. The data collected using the mobile terminal 228 is synchronized with the data that is stored in the computer 224 through a synchronization operation 230. Then the data which has been synchronized on the computer 224 is uploaded to a central data store 234 through a data upload operation 232.

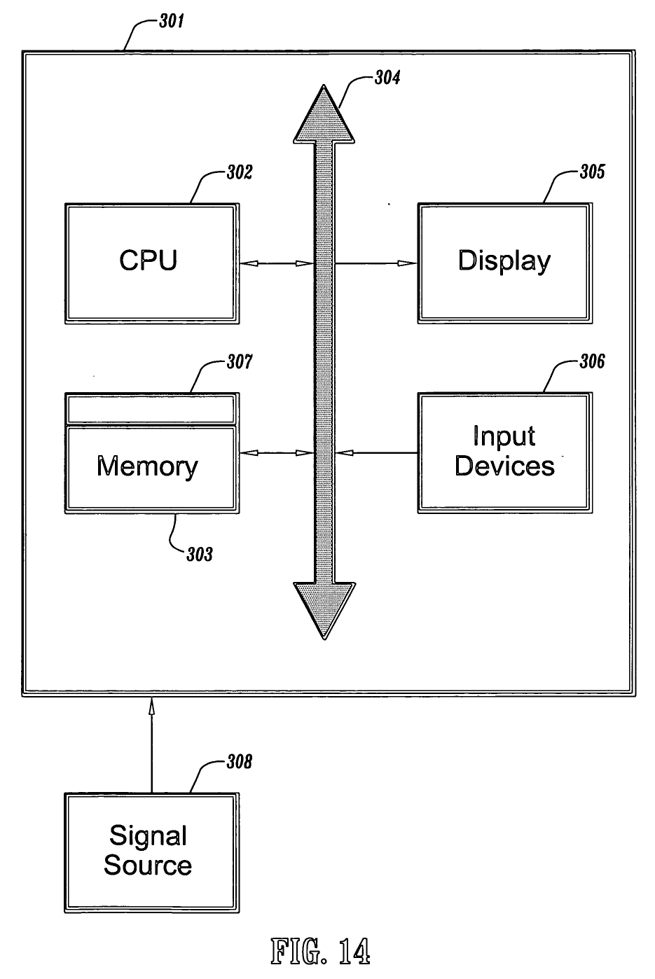

FIG. 14 shows an exemplary computer system used to implement an exemplary embodiment of the invention. Referring to FIG. 13, according to an exemplary embodiment of the present invention, a computer system 301 for implementing the invention can comprise, inter alia, a central processing unit (CPU) 102, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. An exemplary embodiment of the invention can be implemented as a routine 307 that is stored in memory 303 and executed by the CPU 302 to process the signal from the signal source 308. As such, the computer system 301 is a general purpose computer system that becomes a specific purpose computer system when executing the routine 107 of the present invention in an exemplary embodiment of the invention.

The computer platform 301 also includes an operating system and micro instruction code. The various processes and functions described herein may either be part of the micro instruction code or part of the application program (or a combination thereof) which is executed via the operating system. In addition, various other peripheral devices may be connected to the computer platform such as 10, an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed in an exemplary embodiment of the invention. Given the teachings of the present invention provided herein, one of ordinary skill in the related art will be able to contemplate these and similar implementations or configurations of the present invention.

While the present invention has been particularly shown and described with reference to exemplary embodiments thereof, it will be understood by those skilled in the art that various changes in form and details may be made therein without departing from the spirit and scope of the present invention as defined by the appended claims.

1. A datasheet processing method for publishing and collecting datasheets, the method comprising:
performing copy, update and store operations on one or more datasheet forms sourced from a forms database into a local database on a computer system;
assigning at least one of the datasheet forms to one or more jobs from a list of jobs stored on the computer system;
updating one or more mobile terminals by loading the assigned datasheet form from the local database, wherein the mobile terminals stores the assigned datasheet form on a mobile database and the user collects field data by using the assigned datasheet;
synchronizing the mobile terminals with the local database by using the collected field data to update the local database; and
uploading the local database contents that include the assigned datasheet forms and the collected field data received from the mobile terminals to a central computer storage.

2. The method of claim 1, wherein the step of performing comprises:
receiving the datasheets forms in an electronic paper document format, wherein the datasheet forms comprise one or more form fields; and
receiving one or more specifications for the form fields in a markup language format.

3. The method of claim 2, wherein the electronic paper document format is the Portable Document Format (PDF) and the markup language format is the Extendible Markup Language (XML) format.

4. The method of claim 1 further comprises:
performing an updating task on the list of jobs by adding one or more new jobs to the list of jobs.

5. The method of claim 1 further comprises:
performing an updating task on the list of jobs by editing one or more of the data-collection jobs in the list of jobs.

6. The method of claim 1 further comprises:
selecting one or more datasheet forms for assignment to one or more jobs.

7. The method of claim 1 further comprises:
loading the datasheet forms from the local database;
downloading predetermined pre-populated data corresponding to the datasheet forms;
automatically updating the assigned datasheet forms with the collected field data and the pre-populated data; and
automatically backing up the assigned datasheet forms and the collected field data to a backup data store.

8. The method of claim 1 further comprises:
printing the datasheet forms; and
purging the jobs listed in the list of jobs.

9. A mobile data collection system, the system comprising:
a form manager for performing one or more datasheet operations and storing one or more datasheet forms in a markup language format;
a mobile database for storing one or more jobs, forms and collected data;
a job manager for organizing through the jobs the data collected by one or more mobile terminals using the datasheet forms which are stored in the mobile database by the form manager module; and
a data collector for performing data operations on the data collected through the mobile terminals and the datasheet forms.

10. The system of claim 9, wherein the job manager obtains the datasheet forms from the form manager and allows the user to assign one or more datasheet forms obtained to the jobs from a list of jobs.

11. The system of claim 10, wherein the job manager enables editing and adding of the jobs from the list of jobs based on a user input.

12. The system of claim 11, wherein the job manager prints the datasheet forms and purges jobs from a list of jobs.

13. The system of claim 9, wherein the data collector synchronizes the data collected by the mobile terminals on the mobile database with the datasheet forms and then uploads the data collected by the mobile terminals and datasheet forms to the database.

14. The system of claim 9, wherein the data collector loads the datasheets from the database and updates the datasheet forms with pre-populated data.

15. The system of claim 14, wherein the data collector automatically updates the database with the updated datasheet forms and performs an automatic backup of the updated database.

16. The system of claim 9, wherein the mobile database comprises tables for job related information, event and unit lookups, and datasheets.

17. A program storage device readable by machine, tangibly embodying a program of instructions executable by the machine to perform method steps for collecting and handling form data, the method steps comprising:
performing copy, update and store operations on one or more datasheet forms sourced from a forms database into a local database on a computer system;
assigning at least one of the datasheet forms to one or more jobs from a list of jobs stored on the computer system;
updating one or more mobile terminals by loading the assigned datasheet form from the local database, wherein the mobile terminals stores the assigned datasheet form on a mobile database and the user collects field data by using the assigned datasheet;
synchronizing the mobile terminals with the local database by using the collected field data to update the local database; and
uploading the local database contents that include the assigned datasheet forms and the collected field data received from the mobile terminals to a central computer storage.

18. The device of claim 17 further comprises instructions for:
performing an updating task on the list of jobs by editing one or more of the jobs in the list of jobs.

19. The device of claim 17 further comprises instructions for:
selecting one or more datasheet forms for assignment to one or more jobs.

20. The device of claim 17 further comprises instructions for:
loading the data-sheets from the local database;
downloading predetermined pre-populated data corresponding to the datasheets; and
automatically updating the assigned datasheet forms and the collected field data; and
automatically backing up the assigned datasheet forms and the collected field data to a backup data store.
